(19) United States
(12) Patent Application Publication
(10) Pub. No.: US 2024/0037200 A1
(43) Pub. Date: Feb. 1, 2024

(54) Real Estate Transactions Authorization Device and Method of Use Thereof

(71) Applicant: Tywana Woodley, Philadelphia, PA (US)

(72) Inventor: Tywana Woodley, Philadelphia, PA (US)

(21) Appl. No.: 18/187,746

(22) Filed: Mar. 22, 2023

Related U.S. Application Data
(60) Provisional application No. 63/393,568, filed on Jul. 29, 2022.

(51) Int. Cl. G06F 21/32; G06Q 50/16

(52) U.S. Cl. CPC G06F 21/32; G06Q 50/16

(57) ABSTRACT

The present invention relates to a novel real estate documents identification and verification device and associated system and method. The device includes a fingerprint scanner for scanning a fingerprint of a user for displaying properties tied to the user. The device stores the property documents and fingerprint(s) in an internal memory thereof and a touch-based display screen for displaying the property documents. In some embodiments, the device is configured to transfer the captured fingerprint onto the property documents for performing an authorized transaction. The device can be used for selecting a property and verifying a user as an authorized user of the property. The device is designed to ensure that a property is tied to a person via their fingerprint to eliminate any fraud.

### CROSS-REFERENCE TO RELATED APPLICATION

The present application claims priority to, and the benefit of, U.S. Provisional Application No. 63/393,568, which was filed on Jul. 29, 2022, and is incorporated herein by reference in its entirety.

### FIELD OF THE INVENTION

The present invention relates generally to the field of biometric verification devices. More specifically, the present invention relates to a novel desk unit for collecting fingerprints of users and use them for identifying and verifying real estate transaction identification. The device ties fingerprints of a user to a property deed or any other notary document therefore, preventing any dispute and enables transaction processing only after positive identification through fingerprints. The device stores fingerprints and documents in a secure and encrypted form. Accordingly, the present disclosure makes specific reference thereto. Nonetheless, it is to be appreciated that aspects of the present invention are also equally applicable to other like applications, devices, and methods of manufacture.

### BACKGROUND

By way of background, a real estate transaction is the process that occurs when a seller offers their home or any other property for sale, and a buyer agrees to purchase that property. Such transactions may involve a real estate professional. Closing a real estate transaction requires multiple steps. The steps vary depending on the type of transaction and state regulations. Before the closing can take place, and before the title of the property transfers to the buyer, a multitude of activities and tasks must be completed on time.

Real estate frauds are very common across the globe and the crime of real estate fraud occurs when one person in a real estate transaction makes false representations of relevant information to another person in the transaction. Some individuals engage in fraudulently selling a property. A seller can make false statements to a buyer about a property they are selling or, a seller can fail to tell a prospective buyer an important fact about the condition of the property they are selling in order to make the sale. Current systems and methods do not provide relevant and correct information to homeowners and realtors and they may have trouble with others getting information on properties and ultimately stealing them.

Individuals do not have systems to verify the identity and ownership of the seller (and of buyer) before preparing and authorizing a real estate transaction. As a result, individuals also lack the means to fight for their property rights in court with a lawyer. A lot of money and time are wasted in getting the authorization and verification done during a real estate transaction.

Individuals often use duplicate or forged signatures to commit real estate fraud. There does not exist an efficient means to protect against such forged signatures in the current systems. Individuals desire an improved way of authorizing real estate documents.

Therefore, there exists a long-felt need in the art for a device and system that provide an easy way of verifying authenticity of real estate property documents. There is also a long-felt need in the art for a method that can be used by property sellers, buyers, realtors, and authorities to prevent real estate fraud. Additionally, there is a long-felt need in the art of a way for only authorized individuals to transact real estate properties. Moreover, there is a long-felt need in the art for a device that eliminates requirement of manually signing property documents. Further, there is a long-felt need in the art for a device that improves authenticity of real estate transactions. Finally, there is a long-felt need in the art for a unique system that offers a way for positive identification of a user before a real estate transaction can be finalized.

The subject matter disclosed and claimed herein, in one embodiment thereof, comprises a fingerprint enabled real estate transaction authentication device. The device can enable a positive identification of a user before a transaction can be finalized and offers a way to transfer the image of a fingerprint scan onto a property deed. The device further comprising a touch-based display screen for displaying property deeds, the display screen is also configured to receive one or more inputs from a user, a fingerprint scanner for capturing one or more fingerprints of users, an internal memory for storing fingerprints of users and property deeds, a printer for printing property deeds, wherein the display screen is configured to display property deeds of a user whose fingerprint is successfully authenticated, the displayed property deeds are retrieved from the internal memory and further, for transacting a real estate transaction, the captured fingerprints are transferred to the displayed deeds and are stored in an internal memory of the device. The transactions are only processed when fingerprints are authenticated thereby eliminating any unauthorized users for the real estate property transactions.

In this manner, the real estate transaction verification device of the present invention accomplishes all of the forgoing objectives and provides users with a desk unit that collects fingerprints and enables them to be used for real estate transaction identification and verification. The device ensures that a property is tied to an authenticated person via their fingerprint so any disputes with the deed cannot be fought and only authorized users can perform a real estate transaction.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a real estate transaction identification and authorization device. The device is designed as a fingerprint enabled signing desk device or kiosk for capturing fingerprints of users. Upon successful capture of fingerprints, the device is configured to display details of the properties on a display screen, wherein the properties are transacted by the user whose fingerprints are captured, thereby enabling only authorized users to transact properties. The device is also configured to transfer captured fingerprints of one or more users associated with a property or notary document being displayed on the display screen for verifying and processing a real estate transaction. The device has an internal memory for storing the captured fingerprints and property details including at least location, size, transaction history, and owners.

The subject matter disclosed and claimed herein, in one embodiment thereof, comprises a fingerprint enabled real estate transaction kiosk device. The kiosk device further comprising a touch-based display screen for displaying property deeds, the display screen is also configured to receive one or more inputs from a user, a fingerprint scanner for capturing one or more fingerprints of users, an internal memory for storing fingerprints of users and property deeds, a printer for printing property deeds, wherein the display screen is configured to display property deeds of a user whose fingerprint is successfully authenticated, the displayed property deeds are retrieved from the internal memory and further, for transacting a real estate transaction, the captured fingerprints are transferred to the displayed deeds and are stored in an internal memory of the device.

In yet another embodiment, a real estate transaction authorization device is disclosed. The device features a display screen for receiving inputs from a user and for displaying real estate documents, a fingerprint scanner for capturing fingerprints of a user for authorizing and verifying real estate transactions, an internal memory, the display screen further displays an option to retrieve one or more real estate documents from an internal memory of the device, an attest documents option to transfer captured one or more fingerprints of the user to displayed real estate documents wherein the transferred fingerprints are used for verifying and authorizing the real estate transactions.

In yet another embodiment, a real estate transaction identification device is disclosed. The device features a display screen for receiving inputs from a user and for displaying real estate documents; a fingerprint scanner for capturing fingerprints of a user for authorizing, authenticating, and verifying real estate transactions; the display screen is configured to display a property transacted by a user whose fingerprint is successfully captured and authenticated; and, the device transfers the captured fingerprint onto the property deed of the displayed property for transacting a real estate transaction.

In yet another embodiment, a method for performing an authorized transaction of a real estate property is described. The method includes the following steps : (1) displaying the property on a display screen of a fingerprint enabled device; (2) capturing a fingerprint of a user using a fingerprint scanner of the device; (3) authorizing the captured fingerprint of the user; (4) transferring the captured fingerprint on a property deed of the property upon successful authorization of the fingerprint of the user; and, (5) displaying the property deed with applied fingerprint of the user.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a real estate transaction identification device of the present invention in accordance with the disclosed architecture;

FIG. 2 illustrates a flow diagram depicting a process of retrieving and displaying documents by the automated notary device of the present invention in accordance with the disclosed architecture;

FIG. 3 illustrates an exemplary user interface shown by the display screen of the authorized notary documents kiosk of the present invention in accordance with the disclosed architecture;

FIG. 4 illustrates a flow diagram depicting a process of transferring a fingerprint of a user on a notary document for authorizing a transaction using the notary device of the present invention in accordance with the disclosed architecture;

FIG. 5 illustrates a flow chart depicting a process of performing a transaction for a property by authorized individuals using the real estate transaction authorization device in accordance with the disclosed architecture; and

FIG. 6 illustrates a functional block diagram showing the network connection of the real estate transactions kiosk device of the present invention with external servers in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long-felt need in the art for a device and system that provide an easy way of verifying authenticity of real estate property documents. There is also a long-felt need in the art for a method that can be used by property sellers, buyers, realtors, and authorities to prevent real estate fraud. Additionally, there is a long-felt need in the art for a way for only authorized individuals to transact real estate properties. Moreover, there is a long-felt need in the art for a device that eliminates the requirement of manually signing property documents. Further, there is a long-felt need in the art for a device that improves authenticity of real estate transactions. Finally, there is a long-felt need in the art for a unique system that offers a way for positive identification of a user before a real estate transaction can be finalized.

The present invention, in one exemplary embodiment, is a real estate transaction identification and authorization device. The device features a display screen for receiving inputs from a user and for displaying real estate documents, a fingerprint scanner for capturing fingerprints of a user for authorizing and verifying real estate transactions, an internal memory, the display screen further displays an option to retrieve one or more real estate documents from an internal memory of the device, an attest documents option to transfer captured one or more fingerprints of the user to displayed real estate documents wherein the transferred fingerprints are used for verifying and authorizing the real estate transactions.

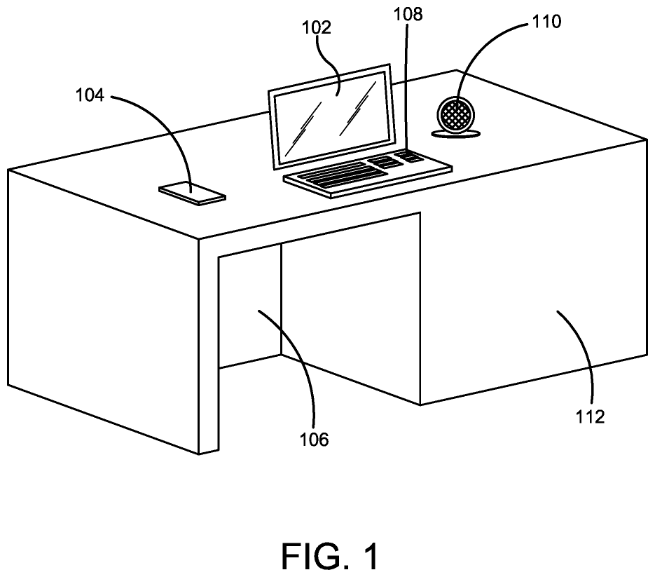

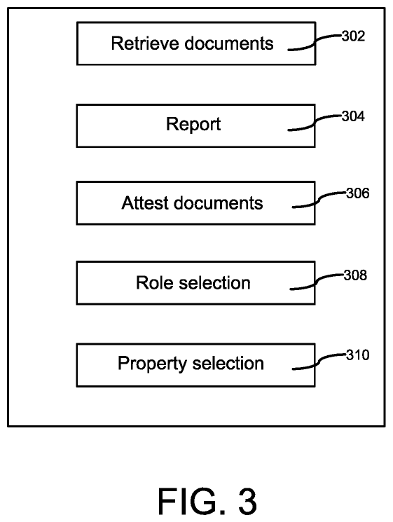

Referring initially to the drawings, FIG. 1 illustrates a perspective view of one potential embodiment of real estate transaction identification device of the present invention in accordance with the disclosed architecture. The real estate transaction identification device 100 of the present invention is designed to assist with storage and verification of personal identification with real estate transactions. The device 100 is designed in the form of a kiosk, wherein the users may identify themselves with a fingerprint scan. Also, the device 100 helps in transferring a fingerprint image onto a property deed and the like, thereby authorizing the documents without requiring a user to manually sign the documents. More specifically, the device 100 has a display screen 102 for displaying property deeds, other documents, and different options such as attesting the document, capturing fingerprints, and more as illustrated in FIG. 3. The display screen 102 can be in the form of a touch screen and can use any conventional display technology including, but not limiting to, LED, LCD, OLED, and more.

A biometric scanner 104 is positioned beside the display screen 102 for capturing the fingerprint of a user. The scanner 104 is a robust biometric fingerprint scanner device tailored to operate for multiple commercial, civil, and government applications. In one exemplary embodiment, the scanner 104 is a scratchproof optical scanner, but can also be any of capacitance scanners, ultrasonic scanners, and thermal scanners in different embodiments of the present invention. In one embodiment, the biometric scanner 104 detects a user when the user touches or presses the fingerprint scanner 104 with a finger. In other embodiments, the fingerprint scanner 104 detects the user when the user's finger is within proximity of the fingerprint scanner 104.

An internal memory 106 of the notary device 100 is used for storing an image of the scanned fingerprint of a user. The internal memory 106 is also configured to store property deeds and other notary documents in digital format such that a document for which a user is authorized is retrieved from the memory 106 and displayed on the display screen 102. The internal memory 106 may include random access memory and/or non-volatile memory, such as one or more magnetic disk storage devices, one or more optical storage devices, and/or flash memory. The internal memory 106 may store an operating system (not shown), such as LINUX, UNIX, OS X, WINDOWS, or an embedded operating system and more.

In addition to the touch interface of the display screen 102, the device 100 also has a keyboard 108 for providing input to the device 100. The keyboard 108 can be used for selecting one or more options offered by the device 100 for easily verifying and including fingerprint on the property documents and other deeds. The keyboard 108 can be a physical keyboard or can be a touch-based keyboard. For additional security of the device 100 and an additional means of verifying a user, a webcam 110 is positioned on the device 100 for recording video of a user using the device 100. In some embodiments, the webcam 110 can be used for video identification of a user before enabling the user to access a document displayed on the display screen 102.

For accessing physical documents by a user, a notary document printer 112 is integrated into the device 100. The printer 112 is designed to print in an appropriate format required by the authorities and an appropriate format can be selected by a user. It should be noted that the print option is accessible to a user only after successful biometric authentication of the user.

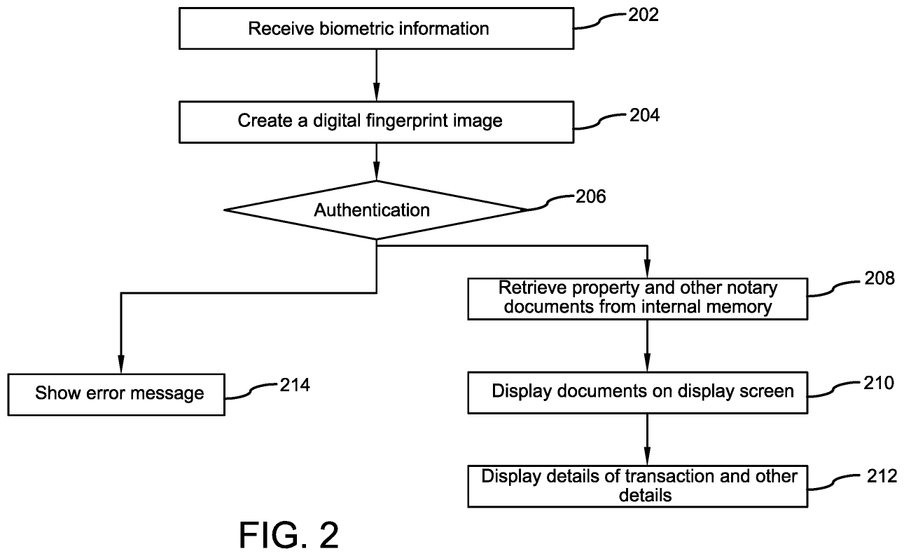

FIG. 2 illustrates a flow diagram depicting a process of retrieving and displaying documents by the automated notary device of the present invention in accordance with the disclosed architecture. Initially, when a user places one or more fingers on the biometric scanner of the device, the fingerprint information is received by the device (Step 202). Using the image processor associated with the scanner, a digital fingerprint image of the user's fingerprint is created for processing and authentication (Step 204). Then, authentication of the fingerprint image is performed by comparing with stored fingerprints in the device or at a remote server (Step 206).

In situations where the authentication is successful, at step 208, the transacted documents of the user are retrieved from the internal memory of the device. In the next step, the retrieved documents are displayed on the display screen of the device for user processing (Step 210). One important advantage of the device of the present invention is to display the details of transactions, dates, amount, and any other conditions related to the documents being displayed on the display screen. Such details are either displayed simultaneously or can be selectively displayed upon input of a user (Step 212). In situations where the authentication is unsuccessful, an error message is shown to the user, thereby preventing unauthorized access of documents to a user (Step 214).

FIG. 3 illustrates an exemplary user interface shown by the display screen 102 of the authorized notary documents kiosk of the present invention in accordance with the disclosed architecture. The touch display screen 102 is configured to display a plurality of options for users to perform actions regarding retrieval and verification of regulatory documents such as property deed, tax documents, and more. It should be noted that the plurality of options displayed on the screen 102 can vary depending on the regulations in a specific geographical area.

As illustrated, retrieve documents option 302 allows a user to retrieve the already transacted documents of a user whose fingerprint authentication is done successfully. The documents are stored in a secured manner using encryption. Based on the successful authentication of a user, the associated documents of the user are retrieved and are decrypted using a public decryption key generated on the successful fingerprint authentication. The report option 304 allows a user to report any mistake in the documents of the user and accordingly, a notification can be sent to regulatory authorities for correcting the incorrect information.

An attest documents option 306 allows a user to transfer the scanned fingerprint upon a document for approval and authorization. The digital fingerprint provides a secure way of signing a document such as a property deed and can be used for legal remedies and prevention of fraud. The attest documents option 306 eliminates the requirement of a user to manually sign the documents and thus prevents forgery.

The device 100 can be used by real estate owners, agents, authorizers, regulatory individuals and more and accordingly, for use of the device 100, a role can be selected using the role selection control 308. The documents which are approved or transacted by a user of the device 100 can be displayed on the display screen.

An advantage of the device 100 is that only authenticated users can transact a property such as a home, a business, and the like. A property can be selected using the physical address or using any location identification technique such as Global Positioning System (GPS) by selecting property selection control 310. The authenticated users such as designated owner, legal representative, or more can transact the property, thereby eliminating any fraud or illegal transactions.

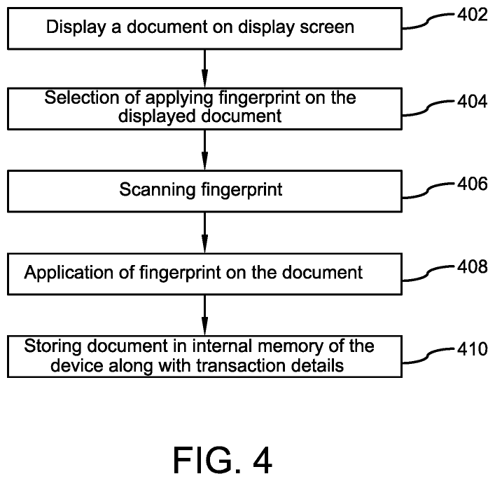

FIG. 4 illustrates a flow diagram depicting a process of transferring a fingerprint of a user on a notary document for authorizing a transaction using the notary device 100 of the present invention in accordance with the disclosed architecture. As illustrated, initially, a document is displayed on the display screen (Step 402). The document can be scanned or uploaded or alternatively can be retrieved from an internal memory of the device 100. Further, the document can be any property document, regulatory document, notary document, and the like.

For applying a fingerprint for digitally signing and authorizing the displayed document, selection of attesting document control is done by the user (Step 404). One or more fingerprints of one or more users can be applied to a document as required per regulations. Thereafter, fingerprints of one or more users are scanned (Step 406) and digital images are appropriately positioned on the document (Step 408). In some embodiments, the device 100 may automatically detect the positions on the document for applying digital signatures. The displayed document is scanned to identify blocks for user attestation and accordingly, fingerprints are transferred.

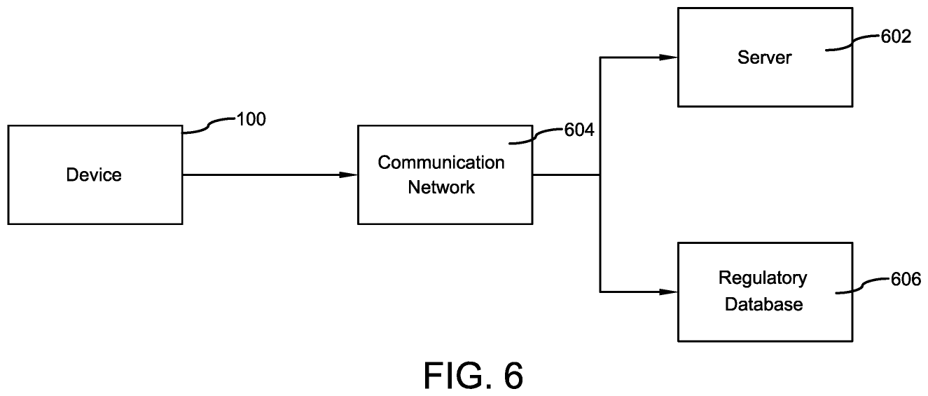

The authorized documents are then updated and are stored in the internal memory of the device 100 (Step 410). Further, the updates are also notified to the concerned regulatory authorities as described in FIG. 6. During storage in internal memory, a check is done on the background verification of users and in case, any negative background information is identified, the users involved in the transaction are notified to enable a safe transaction.

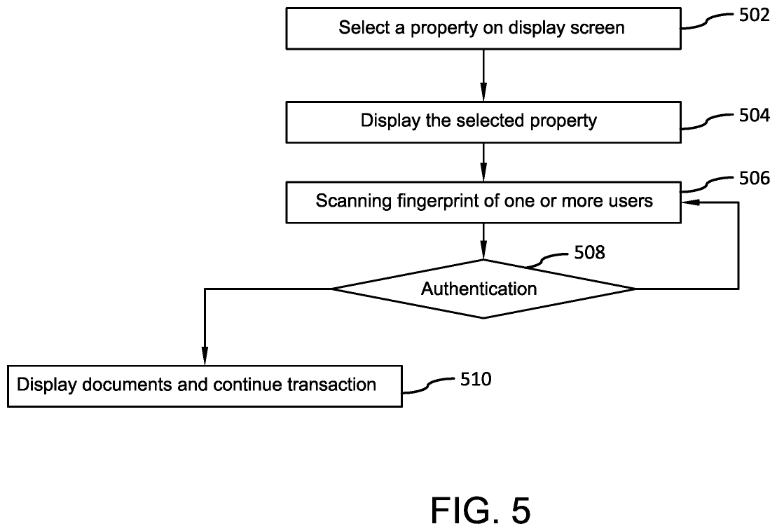

FIG. 5 illustrates a flow chart depicting a process of performing a transaction for a property by authorized individuals using the real estate transaction authorization device in accordance with the disclosed architecture. Initially, a property is selected for display using the display screen (Step 502). The property can be any home, business, or any other type of property listed in a specific geographical area. The selected property is then displayed on the display screen (Step 504). Any publicly available and non-confidential information such as size, address, and more may also be displayed along with the property.

For performing transactions upon the property, a fingerprint is scanned of one or more users wanting to perform a transaction upon the property (Step 506). Then, the device 100 authenticates the fingerprints by comparing one or more scanned fingerprints with the stored fingerprints associated with the displayed property (Step 508). In situations where the authentication is successful, papers associated with the property are displayed for processing and the transaction can be continued by authorized users (Step 510). In situations where the authentication is unsuccessful, the authorized fingerprints are required to be scanned for processing of any transaction.

FIG. 6 illustrates a functional block diagram showing the network connection of the real estate transactions kiosk device of the present invention with external servers in accordance with the disclosed architecture. The device 100 can be connected to an external cloud server 602 for storing all the confidential documents and fingerprints in a secure and encrypted manner. The server 602 can be coupled to a plurality of such devices installed at a plurality of places such as different cities, states, and even countries. The server 602 may include, but are not limited to, personal computers, laptops, mini-computers, mainframe computers, any non-transient and tangible machine that can execute a machine-readable code, cloud-based servers, distributed server networks, or a network of computer systems. The server 602 can be realized through various web-based technologies such as, but not limited to, a Java web-framework, a .NET framework, a personal home page (PHP) framework, or any web-application framework. The server 602 can be maintained by a storage facility management authority or a third-party entity that facilitates service enablement and resource allocation operations.

The device 100 is coupled to a communication network 604 for connecting to external servers. The communication network 604 may include, but not limited to, a wireless channel, a wired channel, a combination of wireless and wired channel thereof. The wireless or wired channel can be associated with a data standard which can be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

Using the communication network, the device 100 is also connected to regulatory databases 606 to receive and transmit transaction information for official records. All the additional details such as fees, date, etc. are also updated.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “real estate transaction authorization device”, “real estate transaction identification device”, “device”, “notary device”, and “real estate transactions kiosk device” are interchangeable and refer to the real estate transaction authorization device 100 of the present invention.

Notwithstanding the forgoing, the real estate transaction authorization device 100 of the present invention can be of any suitable size and configuration as is known in the art without affecting the overall concept of the invention, provided that it accomplishes the above-stated objectives. One of ordinary skill in the art will appreciate that the real estate transaction authorization device 100 as shown in the FIGS. are for illustrative purposes only, and that many other sizes and shapes of the real estate transaction authorization device 100 are well within the scope of the present disclosure. Although the dimensions of the real estate transaction authorization device 100 are important design parameters for user convenience, the real estate transaction authorization device 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A real estate transaction identification device comprising:
an identification device having a display screen for displaying property documents, a scanner for scanning a fingerprint of a user, and an internal memory for storing an image of a scanned fingerprint of a user;
wherein said internal memory for storing said property documents in digital format;
wherein said property documents for which a user is authorized is retrieved from said internal memory and displayed on said display screen;
an interface to said identification device including a touch interface;
wherein said scanner is a biometric fingerprint scanner for authenticating and saving a scanned fingerprint of the user; and
a document printer integrated with said identification device for printing said property documents by the user upon successful said authenticating of the user.

2. The real estate transaction identification device of claim 1, wherein said touch interface is a touch-based keyboard.

3. The real estate transaction identification device of claim 2 further comprising a webcam positioned on said identification device for recording video of the user using said identification device.

4. The real estate transaction identification device of claim 3, wherein said identification device is a kiosk.

5. The real estate transaction identification device of claim 2, wherein said document printer transfers said scanned fingerprint onto said property documents.

6. The real estate transaction identification device of claim 3, wherein said biometric fingerprint scanner is a scratchproof optical scanner.

7. The real estate transaction identification device of claim 3, wherein said biometric fingerprint scanner is selected from a group consisting of a capacitance scanner, an ultrasonic scanner, and a thermal scanner.

8. The real estate transaction identification device of claim 6, wherein said biometric fingerprint scanner detects said scanned fingerprint of the user when the user touches said biometric fingerprint scanner.

9. The real estate transaction identification device of claim 6, wherein said biometric fingerprint scanner detects said scanned fingerprint of the user when the user's finger is within a proximity of said biometric fingerprint scanner.

10. The real estate transaction identification device of claim 9, wherein said internal memory having a random-access memory and a non-volatile memory.

11. The real estate transaction identification device of claim 10, wherein said internal memory having a storage device selected from a group consisting of a magnetic disk storage device, an optical storage device, and a flash memory.

12. The real estate transaction identification device of claim, 11, wherein said internal memory having an operating system selected from a group consisting of a LINUX, a UNIX, an OS X, and a WINDOWS.

13. The real estate transaction identification device of claim 12, wherein said display screen is a touch screen.

14. The real estate transaction identification device of claim 13, wherein said touch screen is a screen selected from a group consisting of an LED, an LCD, and an OLED.

15. A real estate transaction identification device comprising:
an identification device having a display screen for displaying property documents, a scanner for scanning a fingerprint of a user, and an internal memory for storing an image of a scanned fingerprint of a user;
wherein said internal memory for storing said property documents in digital format;
wherein said property documents for which a user is authorized is retrieved from said internal memory and displayed on said display screen;
an interface to said identification device including a touch interface;
wherein said scanner is a biometric fingerprint scanner for authenticating and saving a scanned fingerprint of the user;
a document printer integrated with said identification device for printing said property documents by the user upon successful said authenticating of the user;
wherein said document printer transfers said scanned fingerprint onto said property documents; and
further wherein said biometric fingerprint scanner detects said scanned fingerprint of the user when the user touches said biometric fingerprint scanner.

16. The real estate transaction identification device of claim 15 further comprising a webcam positioned on said identification device for recording video of the user using said identification device.

17. A method of retrieving and displaying documents by an automated device, the method comprising the steps of:
providing an identification device having a display screen for displaying property documents, a scanner for scanning a fingerprint of a user, and an internal memory for storing an image of a scanned fingerprint of a user;
storing said property documents in digital format in said internal memory;
retrieving from said internal memory and displaying said property documents on said display screen for which a user is authorized, wherein said scanner is a biometric fingerprint scanner;
authenticating and saving a scanned fingerprint of the user;
printing said property documents on a document printer by the user upon successful said authenticating of the user; and
transferring said scanned fingerprint onto said property documents, wherein said biometric fingerprint scanner detects said scanned fingerprint of the user when the user touches said biometric fingerprint scanner.

18. The method of claim 17, wherein said authenticating said scanned fingerprint includes comparing a stored fingerprint in said identification device with said scanned fingerprint.

19. The method of claim 18 further comprising a step of preventing access of said identification device said property documents upon unsuccessful said authenticating said scanned fingerprint.

20. The method of claim 19 further comprising a step of recording video of the user using said identification device.
